(19) United States
(12) Patent Application Publication
(10) Pub. No.: US 2026/0005811 A1
(43) Pub. Date: Jan. 1, 2026

(54) DEMODULATION REFERENCE SYMBOLS

(71) Applicant: NOKIA TECHNOLOGIES OY, Espoo (FI)

(72) Inventors: Petri LUOTO, Oulu (FI); Juha Pekka KARJALAINEN, Sotkamo (FI); Sami-Jukka HAKOLA, Oulu (FI); Timo KOSKELA, Oulu (FI); Youngsoo YUK, Seoul (KR)

(21) Appl. No.: 19/251,961

(22) Filed: Jun. 27, 2025

(30) Foreign Application Priority Data
Jun. 28, 2024 (GB) 2409333.8

(51) Int. Cl. H04L 5/00

(52) U.S. Cl. CPC H04L 5/0048

(57) ABSTRACT

According to an example aspect of the present invention, there is provided an apparatus configured to receive, from a network device, DCI for scheduling PDSCH or a PUSCH, the DCI indicating a maximum number of demodulation reference signal, DMRS, symbol positions for the scheduled PDSCH or PUSCH, wherein the indicated maximum number of DMRS symbol positions is encoded in the DCI as a relative value with respect to a reference maximum number of DMRS symbol positions, receive the scheduled PDSCH or transmit the scheduled PUSCH based on the indicated maximum number of DMRS symbol positions, and use the maximum number of DMRS symbol positions as indicated for the scheduled PDSCH in transmission of a further PUSCH, or use the maximum number of DMRS symbol positions as indicated for the scheduled PUSCH in reception of a further PDSCH.

### CROSS-REFERENCE TO RELATED APPLICATIONS

This application claims priority to Great Britian Application No. 2409333.8, filed on Jun. 28, 2024, which is incorporated herein by reference in its entirety.

### FIELD

The present disclosure relates to packet-based communication of data, such as, for example, in the context of cellular wireless networking.

### BACKGROUND

Wireless communication with a mobile device is conducted over a radio channel which evolves over time, presenting challenges to successful communication. To enable correcting for the effects of the radio channel, transmission over the radio channel may be provided with reference symbols, such as demodulation reference symbols, DMRS. DMRS is a physical layer signal which may be used as a reference signal for decoding a physical shared channel, such as a physical downlink shared channel or a physical uplink shared channel. The DMRS may take the form of one or more OFDM symbols embedded in the transmission.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions, receive the scheduled physical downlink shared channel or transmit the scheduled physical uplink shared channel based on the indicated maximum number of DMRS symbol positions, and use the maximum number of DMRS symbol positions as indicated for the scheduled physical downlink shared channel in transmission of a further physical uplink shared channel, or use the maximum number of DMRS symbol positions as indicated for the scheduled physical uplink shared channel in reception of a further physical downlink shared channel.

According to a second aspect of the present disclosure, there is provided a method, comprising receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions, receiving the scheduled physical downlink shared channel or transmitting the scheduled physical uplink shared channel based on the indicated maximum number of DMRS symbol positions, and using the maximum number of DMRS symbol positions as indicated for the scheduled physical downlink shared channel in transmission of a further physical uplink shared channel, or using the maximum number of DMRS symbol positions as indicated for the scheduled physical uplink shared channel in reception of a further physical downlink shared channel.

According to a third aspect of the present disclosure, there is provided a non-transitory computer readable medium having stored thereon a set of computer readable instructions that, when executed by at least one processor, cause an apparatus to at least receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions, receive the scheduled physical downlink shared channel or transmit the scheduled physical uplink shared channel based on the indicated maximum number of DMRS symbol positions, and use the maximum number of DMRS symbol positions as indicated for the scheduled physical downlink shared channel in transmission of a further physical uplink shared channel, or use the maximum number of DMRS symbol positions as indicated for the scheduled physical uplink shared channel in reception of a further physical downlink shared channel.

According to a fourth aspect of the present disclosure, there is provided an apparatus comprising means for receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions, receiving the scheduled physical downlink shared channel or transmitting the scheduled physical uplink shared channel based on the indicated maximum number of DMRS symbol positions, and using the maximum number of DMRS symbol positions as indicated for the scheduled physical downlink shared channel in transmission of a further physical uplink shared channel, or using the maximum number of DMRS symbol positions as indicated for the scheduled physical uplink shared channel in reception of a further physical downlink shared channel.

According to a fifth aspect of the present disclosure, there is provided an apparatus comprising at least one processing core and at least one memory storing instructions that, when executed by the at least one processing core, cause the apparatus at least to receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, and receive the scheduled physical downlink shared channel or transmit the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to a sixth aspect of the present disclosure, there is provided an apparatus comprising at least one processing core and at least one memory storing instructions that, when executed by the at least one processing core, cause the apparatus at least to transmit, to a user equipment, downlink control information for scheduling a physical downlink shared channel or a physical uplink shared channel, the downlink control information indicating a maximum number of demodulation reference signal, DMRS, symbol positions for the scheduled physical downlink or uplink shared channel, and transmit the scheduled physical downlink shared channel or receive the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to a seventh aspect of the present disclosure, there is provided a method, comprising receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel and receiving the scheduled physical downlink shared channel or transmitting the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to an eighth aspect of the present disclosure, there is provided a method, comprising transmitting, to a user equipment, downlink control information for scheduling a physical downlink shared channel or a physical uplink shared channel, the downlink control information indicating a maximum number of demodulation reference signal, DMRS, symbol positions for the scheduled physical downlink or uplink shared channel and transmitting the scheduled physical downlink shared channel or receiving the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to a ninth aspect of the present disclosure, there is provided a non-transitory computer readable medium having stored thereon a set of computer readable instructions that, when executed by at least one processor, cause an apparatus to at least receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel and receive the scheduled physical downlink shared channel or transmit the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to a tenth aspect of the present disclosure, there is provided a non-transitory computer readable medium having stored thereon a set of computer readable instructions that, when executed by at least one processor, cause an apparatus to at least transmit, to a user equipment, downlink control information for scheduling a physical downlink shared channel or a physical uplink shared channel, the downlink control information indicating a maximum number of demodulation reference signal, DMRS, symbol positions for the scheduled physical downlink or uplink shared channel, and transmit the scheduled physical downlink shared channel or receive the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to an eleventh aspect of the present disclosure, there is provided an apparatus comprising means for receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel and receiving the scheduled physical downlink shared channel or transmitting the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

According to an twelfth aspect of the present disclosure, there is provided an apparatus comprising means for transmitting, to a user equipment, downlink control information for scheduling a physical downlink shared channel or a physical uplink shared channel, the downlink control information indicating a maximum number of demodulation reference signal, DMRS, symbol positions for the scheduled physical downlink or uplink shared channel and transmitting the scheduled physical downlink shared channel or receiving the scheduled physical uplink shared channel based on the indicated maximum number of DMRS symbol positions, wherein the indicated maximum number of DMRS symbol positions is encoded in the downlink control information as a relative value with respect to a reference maximum number of DMRS symbol positions.

### BRIEF DESCRIPTION OF THE DRAWINGS

FIG. 1 illustrates an example system in accordance with at least some embodiments of the present invention;

FIG. 2A illustrates an example scenario in accordance with at least some embodiments of the present invention;

FIG. 2B illustrates an example scenario in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Disclosed herein are methods to control use of demodulation reference signal, DMRS, symbols in a cellular network, such that a base station indicates a maximum number of DMRS symbol positions to be used in a shared channel in the uplink or downlink direction with reference to a previous, or current, maximum number of DMRS symbol positions. A user equipment, UE, may determine the number of DMRS symbols to use in transmitting or receiving the shared channel using this relative indication of the maximum number of DMRS symbol positions. Such indication of the maximum number of DMRS symbol positions, to control the number of DMRS symbols used, with reference to an earlier, reference, maximum number of DMRS symbol positions provides benefits in that changing the DMRS configuration may be performed flexibly, and the number may be increased to a fairly high number using only a few bits. As the number of DMRS symbols appropriate to correct the effects of the radio channel increases with increasing user equipment, UE, velocity, this number may be increased as the UE accelerates and there will only rarely, if ever, be a need to switch from a smallest number to a largest number directly. Thus fewer bits are needed in signaling.

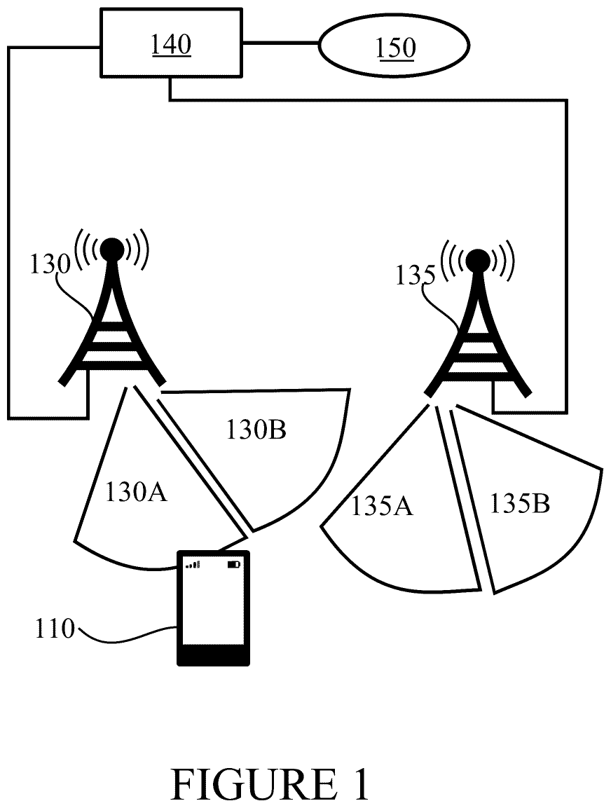

FIG. 1 illustrates an example system in accordance with at least some embodiments of the present invention. This system includes base stations 130, 135 in communication with UEs, such as UE 110. A radio link connects base station 130 with UE 110. The radio link may be bidirectional, comprising an uplink, UL, to convey information from UE 110 toward base station 130, and a downlink, DL, to convey information from the base station 130 toward UE 110. A cellular communication system may comprise hundreds or thousands of base stations, of which only two are illustrated in FIG. 1 for the sake of clarity of the illustration. The base stations may be distributed in that they comprise a centralized unit, CU, and one or more distributed unit, DU. A base station is an example of a base node. Base station 130 is further coupled communicatively with core network node 140, which may comprise, for example, an evolved packet core, EPC, mobility management entity, MME, a home subscriber server, HSS, a 5G unified data repository, UDR, a call session control function, CSCF, or a 5G access and mobility management function, AMF. The core network node 140 may be coupled with further core network nodes, and with a network 150, which may comprise the Internet or a corporate network, for example. The system may communicate with further networks via network 150. Examples of the further core network nodes, which are not illustrated in FIG. 1 for the sake of clarity, include gateways and subscriber information repositories. Core network nodes may be virtualized in the sense that they may run as software modules on computing substrates, such that more than one virtualized network node may run on a same physical computing substrate. The network may be configured to function in accordance with a suitable cellular standard such as long term evolution, LTE, fifth generation, 5G, which is also known as New Radio, NR, or sixth generation, 6G standards as defined by the 3^{rd} generation partnership project, 3GPP. To obtain interoperation, UEs attaching to the network are configured to support a same standard as the network.

Base station 130 controls, in the example of FIG. 1 cells 130A and 130B, of which UE 110 is in the situation illustrated in FIG. 1 attached with cell 130A, and base station 135 controls, in the example of FIG. 1, cells 135A and 135B. The number of cells, or beams, may be in excess of what is illustrated in FIG. 1. It is also possible that a base station has a single cell or beam. While illustrated as sector-shaped, cells of a same base station may be omnidirectional and operate on different frequencies, for example. A mobility event may comprise a switch from one beam to another beam of the same cell, or a switch from one cell to another cell. To support mobility procedures, UEs, including UE 110, are configured to conduct mobility measurements to measure signal strengths of adjacent beams and/or cells, and report results of these measurements to the network, which may then take a decision concerning a mobility event, such as a beam change or a cell switch.

Base stations, BS, such as base stations 130 and 135, are configured to transmit various kinds of information to UEs. In addition to payload, such as the content of voice and video calls, application data and transferred user files, base stations transmit various kinds of configuration information to control the functioning of UEs in their cells. This configuration information includes grants to use air interface resources for UL and DL, for example.

The base stations are configured to control the use of DMRS in physical downlink shared channel, PDSCH, and physical uplink shared channel, PUSCH, transmissions. The PDSCH is transmitted by the base station side, and the PUSCH is transmitted by the UE side. The UE will follow instructions from the base station to select the DMRS configuration it uses. A maximum number of DMRS symbol positions may be indicated to the UE, such that the UE will then determine based on this indicated maximum number and at least a length of the shared channel transmission, how many DMRS symbols to use, and where to place these DMRS symbols in the transmission. The length may be a length in time, or a number of OFDM symbols which the scheduled PDSCH or PUSCH transmission spans. A DMRS symbol comprises sub-carriers (or resource elements) carrying a reference signal for coherent demodulation of the scheduled physical downlink or uplink shared channel. For example, a table such as Table 1 may be used to determine the DMRS configuration:

TABLE 1

| | DM-RS positions l̅ | | | | | |
|---|---|---|---|---|---|---|
| | PDSCH mapping | | | | | |
| | dmrs-AdditionalPosition | | | | | |
| l_{d} in symbols | pos0 | pos1 | pos2 | pos3 | pos4 | pos5 |
| 2 | — | — | — | — | — | — |
| 3 | l₀ | l₀ | l₀ | l₀ | l₀ | l₀ |
| 4 | l₀ | l₀ | l₀ | l₀ | l₀ | l₀ |
| 5 | l₀ | l₀ | l₀ | l₀ | l₀ | l₀ |
| 6 | l₀ | l₀ | l₀ | l₀ | l₀ | l₀ |
| 7 | l₀ | l₀ | l₀ | l₀ | l₀ | l₀ |
| 8 | l₀ | l₀, 7 | l₀, 7 | l₀, 7 | l₀, 7 | l₀, 7 |
| 9 | l₀ | l₀, 7 | l₀, 7 | l₀, 7 | l₀, 7 | l₀, 7 |
| 10 | l₀ | l₀, 9 | l₀, 6, 9 | l₀, 6, 9 | l₀, 6, 9 | l₀, 6, 9 |
| 11 | l₀ | l₀, 9 | l₀, 6, 9 | l₀, 6, 9 | l₀, 6, 9 | l₀, 6, 9 |
| 12 | l₀ | l₀, 9 | l₀, 6, 9 | l₀, 5, 8, 11 | l₀, 5, 8, 11 | l₀, 5, 8, 11 |
| 13 | l₀ | l₀, l₁ | l₀, 7, 11 | l₀, 5, 8, 11 | l₀, 5, 8, 11, 13 | l₀, 5, 8, 11, 12, 13 |
| 14 | l₀ | l₀, l₁ | l₀, 7, 11 | l₀, 5, 8, 11 | l₀, 5, 8, 10, 12 | l₀, 5, 8, 10, 12, 13 |

This example table relates to PDSCH, in the left-most column is the PDSCH duration l_{d} in symbols, while the l₀ position is set by higher layers and may be zero, 2 or 3 depending on a mapping type used. The information in the table enables a determination as to which OFDM symbols will carry DMRS. The dmrs-AdditionalPosition is a variable defined by the maximum number of DMRS symbol positions, such that a value of dmrs-AdditionalPosition of zero corresponds in the table to pos0 (0 DMRS additional position, i.e. maximum number of DMRS symbol position=1), one corresponds to pos1 (1 DMRS additional position, i.e. maximum number of DMRS symbol position=2), two corresponds to pos2 (2 DMRS additional positions, i.e. maximum number of DMRS symbol position=3), three corresponds to pos3 (3 DMRS additional positions, i.e. maximum number of DMRS symbol position=4), four corresponds to pos4 (4 DMRS additional positions, i.e. maximum number of DMRS symbol position=5), and five corresponds to pos5 (5 DMRS additional positions, i.e. maximum number of DMRS symbol position=6),. As the maximum number of DMRS symbol positions defines in quantitative terms a tendency and propensity to place DMRS positions in the shared channel, it conveys a DMRS time density configuration which is usable in determining how many and which symbols of the shared channel will carry DMRS symbols. Thus the number and placement of DMRS symbols for PDSCH may be determined using the maximum number of DMRS symbol positions, the length in symbols of the PDSCH and the l₀ parameter, which as noted above may be zero, this being the first symbol. A similar process may be used for PUSCH, based on the length in symbols of the PUSCH, the maximum number of DMRS symbol positions and an l₀ parameter. As can be seen from the table, the transmission always has at least one DMRS symbol. The relationship between the dmrs-AdditionalPosition variable and the maximum number of DMRS symbol positions may be formulated as the dmrs-AdditionalPosition being the maximum number of DMRS symbol positions decremented by one, for example.

The maximum number of DMRS symbol positions may be indicated to the UE in a radio resource control, RRC, message from the base station. On the other hand, as the optimum number of DMRS symbols depends on how fast the UE moves, it is useful to be able to modify the maximum number of DMRS symbol positions dynamically, that is, more often than is convenient using RRC signaling. One manner of performing this is using a downlink control information, DCI, message to indicate the maximum number of DMRS symbol positions to the UE. This is convenient as the DCI is used to schedule PDSCH and PUSCH, wherefore a same DCI may be used to both schedule a PDSCH/PUSCH transmission and indicate the maximum number of DMRS symbol positions for this transmission. An alternative to using DCI is to use medium access control, MAC, control element, CE, messages to inform the UE of the maximum number of DMRS symbol positions for subsequent PDSCH and/or PUSCH. When DCI is used, it may be of a format 0_1 or 0_2 for PUSCH or format 1_1 or 1_2 for PDSCH, as specified by the 3GPP, for example.

The indication of the maximum number of DMRS symbol positions may be performed as a relative indication with respect to a reference maximum number of DMRS symbol positions, the reference number being a current maximum number of DMRS symbol positions, for example. A benefit of indicating the maximum number of DMRS symbol positions relative to the reference value is that fewer bits are needed than when using an absolute indication which indicates the maximum number of DMRS symbol positions without reference to a reference value. For example, when there may be a high number of DMRS symbols, indicating the exact maximum number of DMRS symbol positions in each DCI would consume more bits than indicating whether to maintain the configuration unchanged, or increase or decrease it by one position. This is the more so, since the UE cannot change its velocity by an arbitrary increment in a short period of time and consecutive DCI messages may be used to follow the acceleration of the UE in case the UE changes from a largely stationary state to moving fast in a high-speed train, for example.

In operation, a UE may receive an initial maximum number of DMRS symbol positions from an RRC message, for example. This initial number serves as the first reference maximum number of DMRS symbol positions. Alternatively, a default maximum number of DMRS symbol positions may serve as the initial number and the first reference maximum number of DMRS symbol positions. Subsequently, the UE may follow relative indications of changes to the maximum number of DMRS symbol positions, the relative indications provided in DCI and/or MAC CE messages, for example. UEs may be configured by base stations, for example by RRC messages, to begin and to cease, respectively, adapting the maximum number of DMRS symbol positions based on the relative indications. In the absence of relative indications, absolute indications may be used, for example an initial maximum number of DMRS symbol positions as configured over RRC.

The maximum number of DMRS symbol positions as adjusted by the relative indication becomes a new reference maximum number of DMRS symbol positions. To be more precise, the UE may be configured to start using the adjusted maximum number of DMRS symbol positions as the new reference responsive to transmitting a positive acknowledgement of a PDSCH transmission decoded in the UE based on the adjusted maximum number of DMRS symbol positions. In the uplink direction, the UE may be configured to start using the adjusted maximum number of DMRS symbol positions as the new reference responsive to receiving a positive acknowledgement from the base station of a PUSCH transmitted from the UE using the adjusted maximum number of DMRS symbol positions. On the base station side, likewise the base station may be configured to take the adjusted maximum number of DMRS symbol positions as the new reference responsive to a positive acknowledgement from the UE of a PDSCH sent using the adjusted value, or successfully decoding in the base station a PUSCH using the adjusted value. The new reference maximum number of DMRS symbol positions is used for PDSCH or PUSCH scheduled after the new reference is established, thus these PDSCH or PUSCH transmissions are scheduled subsequently to the establishment of the new reference.

Table 2 presents an example relative indication of the maximum number of DMRS symbol positions, using two bits:

TABLE 2

| Value | Definition |
|---|---|
| 00 | No change for maximum |
| | number of DMRS symbol |
| | positions |
| 01 | reserved |
| 10 | Increase by 1 symbol position |
| 11 | Decrease by 1 symbol position |

Receipt of “00” results in the reference maximum number of DMRS symbol positions remaining in use, whereas receipt of “10” results in changing the reference maximum number of DMRS symbol positions by incrementing it by one, and “11” results in decrementing the reference maximum number of DMRS symbol positions by one. Using two bits as an absolute indication would only enable indicating four possibilities, whereas the relative indication enables switching between more DMRS states. When using a two-bit relative indication, one of the values, “01” in the example of Table 2, may be used to indicate an increase by two symbol positions, or alternatively a decrease of two symbol positions. The increase may be more useful as in case the UE's state of motion changes quickly more DMRS symbols may be needed with little delay, however reducing the number of DMRS symbol positions is not an urgent task.

Table 3 indicates an example relative indication of the maximum number of DMRS symbol positions using three bits:

TABLE 3

| Value | Definition |
|---|---|
| 000 | No change for maximum number of |
| | DMRS symbol positions |
| 001 | Increase by 1 symbol position |
| 010 | Increase by 2 symbol positions |
| 011 | Increase by 3 symbol positions |
| 100 | Decrease by 1 symbol position |
| 101 | Decrease by 2 symbol positions |
| 110 | Decrease by 3 symbol positions |
| 111 | reserved |

In some embodiments, the base station is configured to instruct the UE to switch between the two-bit relative indication and the three-bit relative indication using RRC signalling, for example. Overall, the relative indication of maximum number of DMRS symbol positions is encoded in the DCI (or MAC CE) message using an encoding which the base station and the UE can both understand. Encoding here thus means a manner of conveying information in bits of a signal. This may involve using two or three bits to express the relative indication, for example.

The UEs may be configured to revert the reference maximum number of DMRS symbol positions to a default value in response to a predetermined time interval having elapsed without any new scheduled PDSCH or PUSCH. This default value may correspond to a maximum number of DMRS symbol positions configured by RRC, or a preconfigured default value, for example. The preconfigured default value may be the highest possible value, for example. Using a larger value as default is advantageous, as it is suitable for even adverse channel conditions and in the event channel conditions are benign, it may be dynamically adapted to fewer DMRS symbol positions during use. On the other hand reverting to a small default number might result in link problems in case the UE moves quickly. However symbol positions used for DMRS are not available for conveying payload, wherefore excessive DMRS incurs overhead which reduces the communication capacity of the channel. Thus a balance may be struck between overhead on the one hand, and robustness of channel estimation on the other hand. For this reason, the dynamic DMRS control described herein enables an optimized use of the communication system.

In wireless communication decoding a transmission does not always succeed. Concerning the PDSCH, the UE may be configured to either abstain from using the relatively indicated maximum number of DMRS symbol positions as the new reference maximum number of DMRS symbol positions, or revert back to a default reference maximum number of DMRS symbol positions, responsive to transmitting a negative acknowledgement to the base station responsive to failing to decode the received PDSCH using the relatively indicated maximum number of DMRS symbol positions. In the uplink direction, the UE may either abstain from using the relatively indicated maximum number of DMRS symbol positions as the new reference maximum number of DMRS symbol positions, or revert back to a default reference maximum number of DMRS symbol positions, responsive to a negative acknowledgement of the transmitted PUSCH received from the base station.

Likewise the base station may abstain from using the relatively indicated maximum number of DMRS symbol positions as the new reference maximum number of DMRS symbol positions, or revert back to a default reference maximum number of DMRS symbol positions, as a response to the UE failing to positively acknowledge a PDSCH transmitted using the relatively indicated value, or as a response to the base station failing to decode a PUSCH using the relatively indicated value.

In some embodiments, the UE is configured to use a same maximum number of DMRS symbol positions for PUSCH as was indicated by the base station for PDSDH. Or, the UE is configured to allocate to use a same maximum number of DMRS symbol positions for PDSCH as was indicated by the base station for PUSDH. Thus, for example, if the network indicates to the UE, relatively or absolutely, to use a maximum number of DMRS symbol positions of three for PDSCH, the UE may use the same value, three, for PUSCH without a separate indication from the network concerning PUSCH. This makes sense as the velocity of the UE is the same whether it uses PDSCH or PUSCH. In general, the UE may use the maximum number of DMRS symbol positions indicated for a first one from among the PDSCH and PUSCH when communicating using a second one from among the PDSCH and PUSCH, in the absence of, or despite, an explicit indication of the maximum number of DMRS symbol positions in DCI scheduling the second one. If the velocity of the UE has been followed using relative indications using PDSCH, a newly started PUSCH may use the same value as was most recently used in PDSCH as the first reference maximum number of DMRS symbol positions.

Based on the number of DMRS symbols in the time domain, channel estimation is performed in the UE using time domain interpolation between symbols. This improves channel estimation performance, especially in high mobility and high carrier frequency scenarios. If only a minimum number of DMRS symbols is used, the UE may abstain from the interpolation. The minimum number corresponds to one or two DMRS symbols at the front of the transmission, based on the configuration.

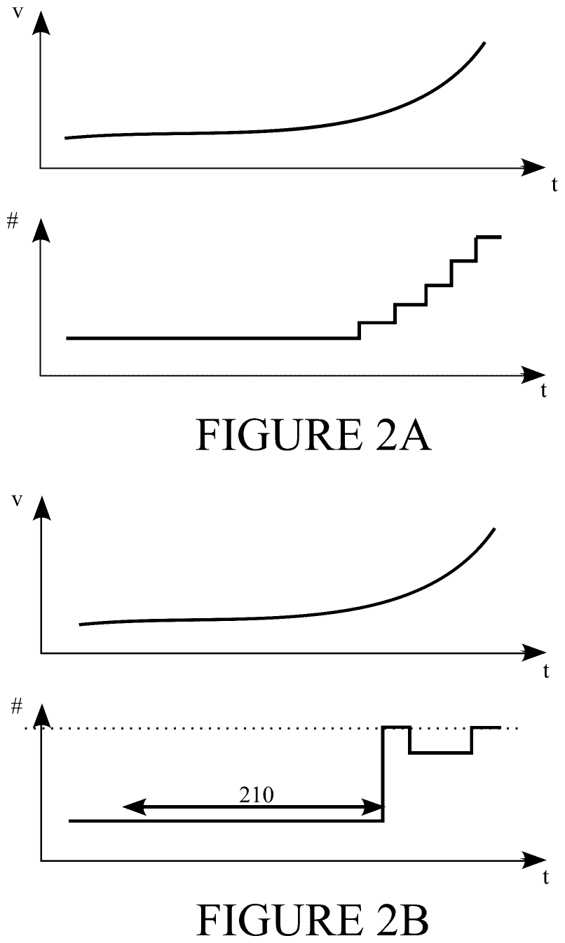

FIG. 2A illustrates an example scenario in accordance with at least some embodiments of the present invention. The upper graph represents a velocity v of a UE as a function of time t, and the lower graph represents a maximum number of DMRS symbol positions #as a function of time t. The time axes are aligned with each other.

In the case of FIG. 2A, the UE has a low velocity and a low maximum number of DMRS symbol positions #to begin with, however as time increases the UE begins to move faster. The base station recognizes the change in the UE's velocity, for example by observing that a channel coherence time between itself and the UE grows shorter. Alternatively, the base station may determine the velocity v of the UE using another method, such as Doppler shift or repeated determinations of the UE's location. However, the channel coherence time is useful, since the DMRS symbols aim to reverse the effects of the channel wherefore the coherence time is directly relevant to the number of DMRS symbols which is optimal. The increase of the maximum number of DMRS symbol positions #results in an increased number of DMRS symbols actually used in the PDSCH or PUSCH transmission, as described herein above.

In the scenario of FIG. 2A, the shared channel transmission is more or less continuous during the time interval represented by the horizontal time axis. As the velocity of the UE changes in a smooth manner, increases of one symbol positions at a time are sufficient to follow the change in velocity. This is well suited to the relative indication mechanism. The maximum number of DMRS symbol positions may comprise a minimum number of DMRS symbol positions and zero or at least one additional DMRS symbol position. The minimum number may be one or two, for example, depending on the configuration.

FIG. 2B illustrates an example scenario in accordance with at least some embodiments of the present invention. The axes of the upper and lower graphs correspond to those of FIG. 2A. A difference to the situation in FIG. 2A is that in the case of FIG. 2B, a break 210 in the downlink or uplink share channel occurs, during which the shared channel is not used. The UE and the base station are configured to revert the reference maximum number of DMRS symbol positions to a default value in response to a predetermined time interval, shorter than break 210, elapsing without scheduled PDSCH or PUSCH, which is illustrated as the sudden jump of the maximum number of DMRS symbol positions #at the end of break 210. The default value, indicated by a dotted line, is in the illustrated scenario slightly more than optimal concerning the velocity of the UE, wherefore the number #decreases after reverting to the default. However, as the UE continues to accelerate, the base station in this example increases the maximum number of DMRS symbol positions once more slightly later, as illustrated in FIG. 2B.

The scenario of FIG. 2B illustrates also why the default value is beneficially a relatively high value, since the velocity of the UE may have changed since the last time the PDSCH or PUSCH was used. If the default value is higher than optimal, it may be reduced by successive relative indications.

The capability to support relative indication of the maximum number of DMRS symbol positions may form part of capability signaling from the UE to the base station which informs the base station of capabilities the UE has. The base station may then activate the relative indication mechanism for a UE which has indicated it is capable of supporting the relative indication. The activating may be performed by providing a dmrs-TimeAllocationChange field to the UE, for example. If this field is false, the UE will only respond to RRC indications of the maximum number of DMRS symbol positions, whereas if this is positive the relative indication of the maximum number of DMRS symbol positions encoded in the DCI/MAC-CE may be applied by the UE.

In some embodiments, the base station may indicate in, for example, an RRC signaling message a DMRS type and a time pattern allocation. A DMRS type refers to an algorithm to determine which symbols of a PDSCH or PUSCH transmission will carry DMRS symbols, for example in 5G technology there are separate Type A and Type B algorithms for mapping the DMRS symbols. In some embodiments, the base station may dynamically change the DMRS type using an indication in DCI. In these cases the DCI may carry two indications: the relative indication of maximum number of DMRS symbol positions and an indication concerning DMRS type. Further, the base station may indicate that the relative indication of maximum number of DMRS symbol positions is active for a specific carrier frequency or frequencies. In higher carrier frequencies, the impact from Doppler shift is greater than at lower frequencies wherefore dynamic control of the number of DMRS symbol positions may be seen as particularly useful when the carrier frequency is higher.

When starting use of PUSCH at a time when PDSCH is already being used, the reference maximum number of DMRS symbol positions of the PDSCH may be set as the reference maximum number of DMRS symbol positions for the PUSCH in both the UE and the base station. The same may be done in case only a brief time, less than a configured threshold time, has elapsed since PDSCH was last used. Likewise, if PDSCH is started when PUSCH is in use or has been in use within the configured threshold time, the reference maximum number of DMRS symbol positions of the PUSCH may be set as the reference maximum number of DMRS symbol positions of the PDSCH in both the US and the base station. In other words, a maximum number of DMRS symbol positions relatively indicated in a DCI scheduling a PDSCH may be used in transmitting a separate, further PUSCH, and/or a maximum number of DMRS symbol positions relatively indicated in a DCI scheduling a PUSCH may be used in receiving a separate, further PDSCH. The further PDSCH and/or further PUSCH may take place in time after the shared channel which was scheduled in the DCI where the maximum number of DMRS symbol positions was indicated.

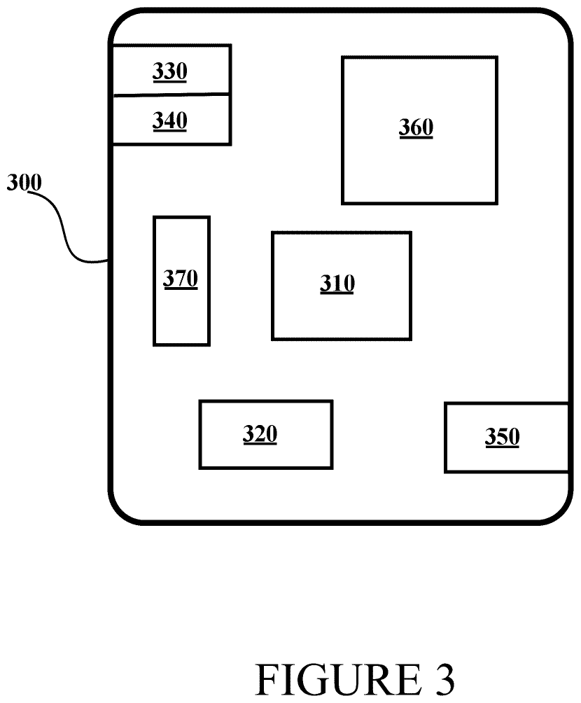

FIG. 3 illustrates an example apparatus capable of supporting at least some embodiments of the present invention. Illustrated is device 300, which may comprise, for example, a mobile communication device such as UE 110 or, in applicable parts, base station 130 of FIG. 1. Comprised in device 300 is processor 310, which may comprise, for example, a single- or multi-core processor wherein a single-core processor comprises one processing core and a multi-core processor comprises more than one processing core.

Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. A processing core or processor may be, or may comprise, at least one qubit. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310, optionally together with memory and computer instructions, may be means for performing method steps in device 300, such as receiving, transmitting and selecting, for example. Processor 310 may be configured, at least in part, by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a UE or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may be a computer readable medium. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part external to device 300 but accessible to device 300. Memory 320 may be transitory or non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, 6G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker or a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

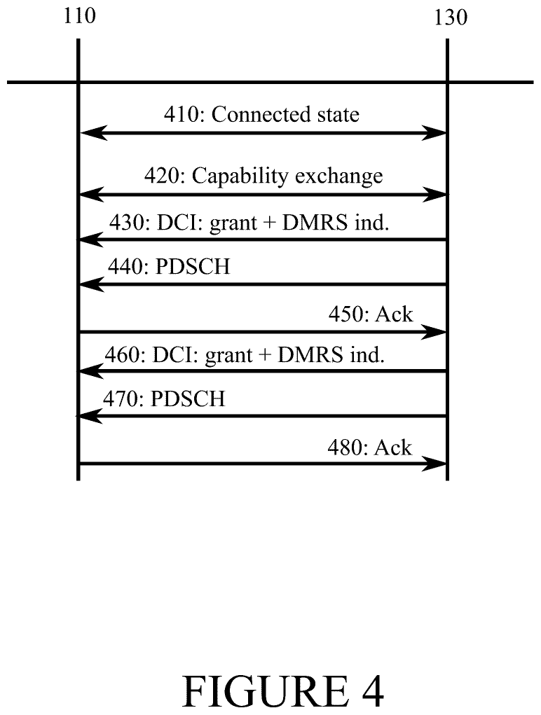

FIG. 4 illustrates signalling in accordance with at least some embodiments of the present invention. On the vertical axes are disposed, on the left, UE 110 and on the right, base station 130, both as in FIG. 1. Time advances from the top toward the bottom.

Phase 410 represents a process that results in UE 110 being in a connected state with respect to the network in which base station 130 is comprised. Phase 420 is a capability exchange between UE 110 and base station 130, wherein the base station requests, and the UE responsively provides, information on capabilities of the UE. For example, one of the capabilities of the UE indicated may be a capability to support relative indication of the maximum number of DMRS symbol positions.

In phase 430 the base station transmits to UE 110 a DCI which comprises a grant of radio resources for a PDSCH transmission to the UE, and, as described herein above, a relative indication of a maximum number of DMRS symbol positions. The relative indication is expressed relative to the reference maximum number of DMRS symbol positions. The base station is configured to select the relative DMRS indication based on the channel coherence time, for example. In phase 440 the base station transmits the PDSCH using the resources indicated in the grant of the DCI of phase 430 and the relatively indicated DMRS configuration. In phase 450, the UE positively acknowledges the receipt of the PDSCH of phase 440.

Phases 460 and 470 repeat phases 430 and 440, respectively. In case the maximum number of DMRS symbol positions needs to be adjusted, this may be done by the base station by selecting a suitable value for the relative indication. Finally, in phase 480 the UE acknowledges that it has received the PDSCH of phase 470. A similar process could apply when the UE transmits using PUSCH.

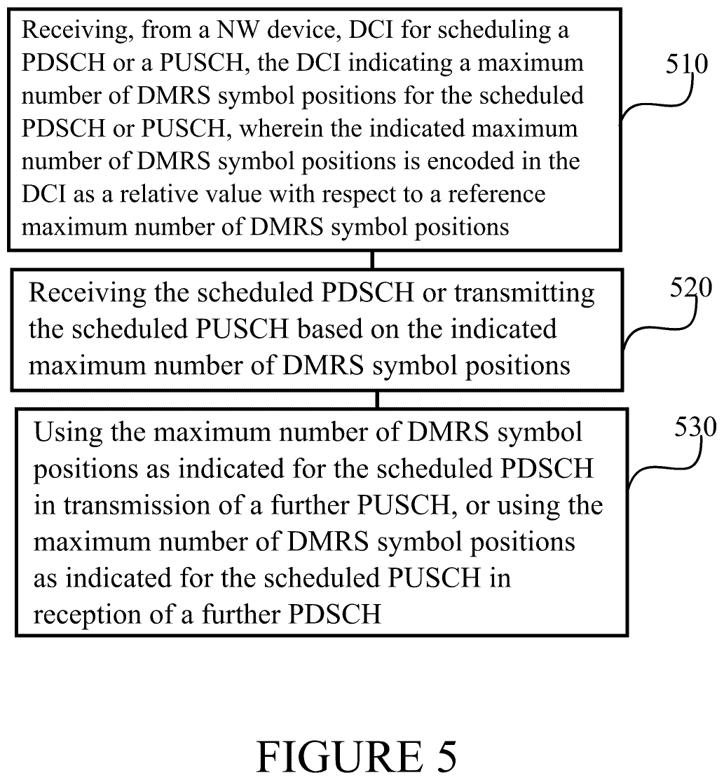

FIG. 5 is a flow graph of a method in accordance with at least some embodiments of the present invention. The phases of the illustrated method may be performed in an apparatus such as UE 110, for example, or in a control device configured to control the functioning thereof, when installed therein.

Phase 510 comprises receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions. Phase 520 comprises receiving the scheduled physical downlink shared channel or transmitting the scheduled physical uplink shared channel based on the indicated maximum number of DMRS symbol positions. Phase 530 comprises using the maximum number of DMRS symbol positions as indicated for the scheduled physical downlink shared channel in transmission of a further physical uplink shared channel, or using the maximum number of DMRS symbol positions as indicated for the scheduled physical uplink shared channel in reception of a further physical downlink shared channel. It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some embodiments of the present invention find industrial application in wireless communication.

### ACRONYMS LIST

DCI downlink control information
DMRS demodulation reference signal
PDSCH physical downlink shared channel
PUSCH physical uplink shared channel
RRC radio resource control
UE user equipment

### REFERENCE SIGNS LIST

| | |
|---|---|
| 110 | user equipment |
| 130, 135 | base station |
| 130A, 130B, | cells |
| 135A, 135B | |
| 140 | core network node |
| 150 | network |
| 210 | break |
| 300-370 | structure of the device of FIG. 3 |
| 410 | phases of the process of FIG. 4 |
| 510-530 | phases of the method of FIG. 5 |

1. An apparatus comprising at least one processing core and at least one memory storing instructions that, when executed by the at least one processing core, cause the apparatus at least to:
receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions;
receive the scheduled physical downlink shared channel or transmit the scheduled physical uplink shared channel based on the indicated maximum number of DMRS symbol positions, and
use the maximum number of DMRS symbol positions as indicated for the scheduled physical downlink shared channel in transmission of a further physical uplink shared channel, or use the maximum number of DMRS symbol positions as indicated for the scheduled physical uplink shared channel in reception of a further physical downlink shared channel.

2. The apparatus of claim 1, wherein the reference maximum number of DMRS symbol positions is one of:
a maximum number of DMRS symbol positions as configured by Radio Resource Control, RRC, signaling; and
a maximum number of DMRS symbol positions as previously indicated for one or more previously scheduled physical downlink or uplink shared channels.

3. The apparatus of claim 1, wherein the apparatus is further caused to:
determine a number of DMRS symbols in the scheduled physical downlink or uplink shared channel based on the indicated maximum number of DMRS symbol positions and on a length in time of the scheduled physical downlink or uplink shared channel.

4. The apparatus of claim 3, wherein a DMRS symbol comprises sub-carriers carrying a reference signal for coherent demodulation of the scheduled physical downlink or uplink shared channel.

5. The apparatus of claim 1, wherein the maximum number of DMRS symbol positions encoded in the downlink control information at least indicates one of:
unchanged maximum number of DMRS symbol positions with respect to the reference maximum number of DMRS symbol positions;
an increase by one DMRS symbol position with respect to the reference maximum number of DMRS symbol positions; and
a decrease by one DMRS symbol position with respect to the reference maximum number of DMRS symbol positions.

6. The apparatus of claim 1, wherein the DMRS time-density configuration encoded in the downlink control information at least indicates one of:
unchanged maximum number of DMRS symbol positions with respect to the reference maximum number of DMRS symbol positions;
an increase by one DMRS symbol position with respect to the reference maximum number of DMRS symbol positions;
a decrease by one DMRS symbol position with respect to the reference maximum number of DMRS symbol positions;
an increase by two DMRS symbol positions with respect to the reference maximum number of DMRS symbol positions; and
a decrease by two DMRS symbol positions with respect to the reference maximum number of DMRS symbol positions.

7. The apparatus of claim 1, wherein the apparatus is further caused to:
use the indicated maximum number of DMRS symbol positions as a new reference maximum number of DMRS symbol positions for a subsequently-scheduled physical downlink or uplink shared channel.

8. The apparatus of claim 7, wherein the scheduled physical downlink or uplink shared channel is a physical downlink shared channel,
and wherein the apparatus is further caused to:
start using the indicated maximum number of DMRS symbol positions as the new reference maximum number of DMRS symbol positions based on transmitting a positive acknowledgement to the network device responsive to successful decoding of the received physical downlink shared channel by the apparatus.

9. The apparatus of claim 8, wherein the apparatus is further caused to:
based on transmitting a negative acknowledgement to the network device responsive to failing to decode the received physical downlink shared channel by the apparatus, either abstain from using the indicated maximum number of DMRS symbol positions as the new reference maximum number of DMRS symbol positions, or revert back to a default reference maximum number of DMRS symbol positions.

10. The apparatus according to claim 7, wherein the scheduled physical downlink or uplink shared channel is a physical uplink shared channel,
and wherein the apparatus is further caused to:
start using the indicated maximum number of DMRS symbol positions as the new reference maximum number of DMRS symbol positions based on a positive acknowledgement of the transmitted physical uplink shared channel received from the network device.

11. The apparatus according to claim 10, wherein the apparatus is further caused to:
responsive to a negative acknowledgement of the transmitted physical uplink shared channel received from the network device, either abstain from using the indicated maximum number of DMRS symbol positions as the new reference maximum number of DMRS symbol positions, or revert back to a default reference maximum number of DMRS symbol positions.

12. The apparatus of claim 1, wherein the apparatus is further caused to revert the reference maximum number of DMRS symbol positions to a default value in response to a predetermined time interval having elapsed without any new scheduled physical downlink or uplink shared channel.

13. The apparatus of claim 12, wherein the default maximum number of DMRS symbol positions is one of:
a maximum number of DMRS symbol positions as configured by Radio Resource Control, RRC, signaling; and
a pre-determined maximum number of DMRS symbol positions.

14. The apparatus of claim 1, wherein the apparatus is further caused to:
receive, from the network device, a configuration message activating or de-activating the encoding of a relative maximum number of DMRS symbol positions in downlink control information.

15. The apparatus of claim 1, wherein the scheduled physical downlink or uplink shared channel is the physical downlink shared channel and apparatus is further caused to interpolate in the time domain between DMRS symbols when the number of DMRS symbols is more than a minimum number.

16. The apparatus of claim 1, wherein the apparatus is a smartphone.

17. A method, comprising:
receiving, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions;
receiving the scheduled physical downlink shared channel or transmitting the scheduled physical uplink shared channel based on the indicated maximum number of DMRS symbol positions, and
using the maximum number of DMRS symbol positions as indicated for the scheduled physical downlink shared channel in transmission of a further physical uplink shared channel, or using the maximum number of DMRS symbol positions as indicated for the scheduled physical uplink shared channel in reception of a further physical downlink shared channel.

18. The method of claim 17, wherein the reference maximum number of DMRS symbol positions is one of:
a maximum number of DMRS symbol positions as configured by Radio Resource Control, RRC, signaling; and
a maximum number of DMRS symbol positions as previously indicated for one or more previously scheduled physical downlink or uplink shared channels.

19. The method of claim 17, further comprising:
determining a number of DMRS symbols in the scheduled physical downlink or uplink shared channel based on the indicated maximum number of DMRS symbol positions and on a length in time of the scheduled physical downlink or uplink shared channel.

20. A non-transitory computer readable medium having stored thereon a set of computer readable instructions that, when executed by at least one processor, cause an apparatus to at least:
receive, from a network device, downlink control information for scheduling a physical downlink shared channel or a physical uplink shared channel, the downlink control information indicating a maximum number of demodulation reference signal, DMRS, symbol positions for the scheduled physical downlink or uplink shared channel, wherein the indicated maximum number of DMRS symbol positions is encoded in the downlink control information as a relative value with respect to a reference maximum number of DMRS symbol positions;
receive the scheduled physical downlink shared channel or transmit the scheduled physical uplink shared channel based on the indicated maximum number of DMRS symbol positions, and
use the maximum number of DMRS symbol positions as indicated for the scheduled physical downlink shared channel in transmission of a further physical uplink shared channel, or use the maximum number of DMRS symbol positions as indicated for the scheduled physical uplink shared channel in reception of a further physical downlink shared channel.
